(19) United States
(12) Patent Application Publication
(10) Pub. No.: US 2011/0129027 A1
(43) Pub. Date: Jun. 2, 2011

(54) WIRELESS COMMUNICATION BASE STATION DEVICE, WIRELESS COMMUNICATION TERMINAL DEVICE, AND METHOD FOR SETTING CYCLIC DELAY

(75) Inventors: Shinsuke Takaoka, Kanagawa (JP); Masayuki Hoshino, Kanagawa (JP)

(73) Assignee: Panasonic Corporation, Osaka (JP)

(21) Appl. No.: 13/055,416

(22) PCT Filed: Jul. 29, 2009
(86) PCT No.: PCT/JP2009/003595

§ 371 Date: Jan. 21, 2011

(30) Foreign Application Priority Data
Jul. 29, 2008 (JP) 2008195135

(51) Int. Cl. H04B 7/26; H04L 27/28; H04B 15/00

(52) U.S. Cl. 375/260; 455/501

(57) ABSTRACT

Provided is a base station enabling an increase of the resource utilization efficiency of a precoded dedicated pilot signal. In a base station (100) used in a wireless communication system in which a plurality of pilot blocks with different cyclic delays are allocated to a plurality of units of the UE, respectively, a cyclic shift setting unit (111) sets delay times of the respective pilot blocks so that pilot blocks adjacent to each other in the plurality of the respective pilot blocks overlap with each other, and a channel estimating unit (106) estimates the channel of each unit of the UE by using a CIR that can be obtained from the dedicated pilot signal precoded by the UE and that exists in the pilot block of each unit of the UE.

### TECHNICAL FIELD

The present invention relates to a radio communication base station apparatus, radio communication terminal apparatus and a cyclic delay setting method.

### BACKGROUND ART

In recent years mobile communication systems have offered diversified services, and are required to transmit not only speech data but also large volume of data such as still image data and moving image data. Therefore, a radio transmission technique for realizing improved spectrum efficiency is required.

As a technique for improving the spectrum efficiency, there is MIMO (Multi-Input Multi-Output) transmission to perform parallel data transmission using a plurality of antennas. Moreover, it is possible to increasingly improve spectrum efficiency by combining MIMO transmission with a precoding technique. Therefore, in standardization of 3GPP (3^{rd} Generation Partnership Project) LTE (Long Term Evolution), the precoding technique is actively being studied.

The precoding technique can be broadly classified into (1) frequency-nonselective precoding to multiply transmission signals with a fixed weight in a certain frequency band and (2) frequency-selective precoding to multiply transmission signals with varying weights in a certain frequency band. Here, it is possible to perform precoding by (cyclic) convolution operation with a weight obtained by performing IDFT (inverse discrete Fourier transform) on a precoding weight in the frequency domain (that is, a precoding weight in the time domain), instead of weight multiplication in the frequency domain.

Frequency-nonselective precoding is performed by multiplying transmission signals by one fixed weight in a certain frequency band as described above. Therefore, when a channel shows frequency selectivity, a precoding weight is optimized only in part of assigned bands (or merely averaged in assigned bands), and therefore transmission performances deteriorate.

On the other hand, frequency-selective precoding is performed by multiplying transmission signals by varying weights in a certain frequency band as described above. By this means, even if a channel has frequency selectivity, it is possible to optimize a precoding weight over all assigned bands. As described above, frequency-selective precoding has a better transmission performance than frequency-nonselective precoding. Therefore, it is preferable to use frequency-selective precoding to increasingly improve spectrum efficiency.

Here, to demodulate a data signal precoded in the transmitting side, using coherent detection in the receiving side, the transmission side needs to multiplex the data signal with a pilot signal known to both the transmitting side and the receiving side and transmits the resultant multiplexed signal to the receiving side, and the receiving side needs to perform channel estimation, that is, channel impulse response (CIR) estimation, using the pilot signal. Either a common pilot signal or a dedicated pilot signal may be used as a pilot signal to demodulate a precoded data signal.

A common pilot signal is transmitted to a plurality of radio communication terminal apparatuses (hereinafter “UE (user equipment)” from a radio communication base station apparatus (hereinafter “base station)”, and is a pilot signal shared between a plurality of UEs. As described above, a common pilot signal is shared between a plurality of UEs, and therefore is not subject to precoding.

On the other hand, dedicated pilot signals are pilot signals transmitted from a base station to a plurality of UEs, individually, and are used by a plurality of UEs, individually. Therefore, it is possible to subject dedicated pilot signals to precoding.

When both a dedicated pilot signal and a data signal are subjected to the same precoding in a base station, in order to demodulate a precoded data signal by coherent detection, each UE may perform processing to remove the corresponding modulated component from a received dedicated pilot signal subjected to precoding, and refer a dedicated pilot signal after removing the modulated component as a channel estimation value used for coherent detection as is. Alternately, each UE may calculate the channel CIR between a base station and each UE from a received dedicated pilot signal subjected to precoding, and multiply the calculated CIR by the precoding weight for each UE.

As described above, a common pilot signal has an advantage of high efficiency of use of resources because it is shared by a plurality of UEs, but has a disadvantage of poorer accuracy of channel estimation than that of a dedicated pilot signal that can be subjected to precoding because it is not subjected to precoding.

On the other hand, a dedicated pilot signal has an advantage of better accuracy of channel estimation than that of a common pilot signal because it is possible to subject a dedicated pilot signal to precoding, but has a disadvantage of poorer efficiency of use of resources because it is transmitted individually to each UE.

Here, it is possible to orthogonally multiplex (delay time-multiplex) dedicated pilot signals from a plurality of UEs (or to a plurality of UEs) by dividing a delay time domain into a plurality of blocks by different delay times and by cyclic-delaying (cyclic-shifting) a dedicated pilot signal from each UE to allocate the precoded CIR between a base station and each UE, to each block (see Non-Patent Literature 1.)

### CITATION LIST

### Non-Patent Literature

[NPL 1] 3GPPP, TS36.211, E-UTRA; Physical Channels and Modulation (Release8) v8.3.0 (2008-05)

### SUMMARY OF INVENTION

### Technical Problem

In the following descriptions, the above block assigned to each UE is referred to as “pilot block.” The length of each pilot block (pilot block length) is determined according to the delay spread of a precoded CIR. That is, a pilot block length is set to a length equal to or longer than the delay spread of a CIR precoded by each UE.

First, impulse responses targeted for channel estimation in the data signal receiving side will be explained with reference to FIGS. 1A, B and C.

When a data signal is not subjected to precoding in the transmitting side, a target for channel estimation using a dedicated pilot signal in the receiving side is a real channel impulse response CIR_real (FIG. 1A) having delay spread only in the positive direction (+). FIG. 1A illustrates a case in which CIR_real is formed by three paths.

Meanwhile, when a data signal is subjected to frequency-selective precoding in the transmitting side, a target for channel estimation using a dedicated pilot signal in the receiving side is an equivalent channel impulse response CIR_eq (FIG. 1C) given by convolution operation of a frequency-selective precoding impulse response IR (FIG. 1B) and a real channel impulse response CIR_real (FIG. 1A). Therefore, in FIG. 1C, the number of apparent paths (the number of paths of equivalent channels) is six.

Here, frequency-selective precoding is performed using varying weights in the frequency domain, so that an impulse response IR of frequency-selective precoding is an impulse response having a component “delay time≠0” in addition to a component “delay time=0” as shown in FIG. 1B. Accordingly, as shown in FIG. 1C, the equivalent channel impulse response CIR_eq (that is, the result of convolution operation of a frequency-selective precoding impulse response IR and a real channel impulse response CIR_real) has delay spread in the negative direction (−) as well as in the positive direction (+). Therefore, the delay spread of the equivalent channel impulse response CIR_eq (FIG. 1C) is greater than the delay spread of the real channel impulse response CIR_real (FIG. 1A) (that is, “CIR_real delay spread<CIR_eq delay spread.)

Therefore, when modulating a data signal subjected to frequency-selective precoding in the transmitting side and demodulating a precoded data signal in the receiving side by coherent detection, the receiving side needs to estimate CIR_eq having delay spread in both the positive direction and the negative direction. Accordingly, when a dedicated pilot signal subjected to frequency-selective precoding is used as a pilot signal used for channel estimation, a plurality of pilot blocks need to be delay time-multiplexed taking into account CIR_eq delay spread.

That is, as shown in FIG. 2, assume that a length equal to or longer than the CIR_eq delay spread (the delay spread in the positive direction+the delay spread in the negative direction) is one block length, it is necessary to divide delay time (t) equivalent to one symbol length into a plurality of pilot blocks, and assign the plurality of pilot blocks having mutually different delay times to a plurality of UEs, respectively. FIG. 2 illustrates a case in which pilot blocks #0 to #3 are assigned to UEs #0 to #3, respectively. Generally, this pilot block delay time-multiplexing is performed by cyclic delay processing (cyclic shift processing) that sets different delay times for a plurality of pilot blocks.

Therefore, for example, UE #0 performs cyclic shift processing on a dedicated pilot signal subjected to frequency-selective precoding such that CIR_eq between UE #0 and a base station stays in pilot block #0 assigned to UE #0. The same applies to the other UEs #1 to #3. Then, a base station extracts CIR_eq of each of pilot blocks #0 to #3 and performs channel estimation.

Here, one symbol length is a finite value, so that it is not possible to delay time-multiplex a number of pilot blocks equal to or more than “one symbol length/CIR_eq delay spread.” That is, if a dedicated pilot signal is subjected to frequency-selective precoding, efficiency of use of resources increasingly deteriorates.

Therefore, it is desired to improve efficiency of use of resources while dedicated pilot signals are subjected to precoding.

It is therefore an object of the present invention to provide a base station, a UE and a cyclic delay setting method to improve the efficiency of use of resources for dedicated pilot signals subjected to precoding.

### Solution to Problem

The base station according to the present invention is a base station in a radio communication system in which a plurality of pilot blocks having mutually different cyclic delays, are assigned to a plurality of UEs, respectively. The base station adopts a configuration to include: an estimating section that performs channel estimation on each of the plurality of UEs, using channel impulse responses that exist in the plurality of pilot blocks and that are obtained from dedicated pilot signals precoded by the plurality of UEs, respectively; and a setting section that sets the cyclic delay for each of the plurality of pilot blocks such that part of one pilot block and part of a neighboring pilot block overlap one another.

The UE according to the present invention is a UE in a radio communication system in which a plurality of pilot blocks having mutually different cyclic delays are assigned to a plurality of UEs. The UE adopts a configuration to include: a precoding section that precodes a dedicated pilot signal; and a transmitting section that transmits the precoded dedicated pilot signal, using a pilot block assigned to the UE, among the plurality of pilot blocks in which respective cyclic delays are set such that part of one pilot block and part of a neighboring pilot block overlap one another.

The cyclic delay setting method according to the present invention is a cyclic delay setting method in a radio communication system in which a plurality of pilot blocks having mutually different cyclic delays are assigned to a plurality of UEs, respectively, and channel estimation are performed for each of the plurality of UEs, using channel impulse responses that exist in the plurality of pilot blocks and that are obtained from dedicated pilot signals precoded by the plurality of UEs, respectively, includes: setting the cyclic delay for each of the plurality of pilot blocks such that part of one pilot block and part of a neighboring pilot block overlap one another.

### Advantageous Effects of Invention

According to the present invention, it is possible to improve the efficiency of use of resources for dedicated pilot signals subjected to precoding.

### BRIEF DESCRIPTION OF DRAWINGS

FIG. 1A shows real channel impulse response CIR_real;

FIG. 1B shows frequency-selective precoding impulse response IR;

FIG. 1C shows equivalent channel impulse response CIR_eq;

FIG. 2 shows pilot block assignment;

FIG. 3 shows a process of generating equivalent channel impulse response CIR_eq;

FIG. 4 is a block diagram showing a configuration of a base station according to Embodiment 1;

FIG. 5 is a block diagram showing a configuration of a UE according to Embodiment 1;

FIG. 6 shows cyclic shift (in the frequency domain) according to Embodiment 1;

FIG. 7A explains cyclic shift setting processing according to Embodiment 1;

FIG. 7B explains cyclic shift setting processing according to Embodiment 1;

FIG. 8 shows pilot block assignment according to Embodiment 1;

FIG. 9A explains CIR_eq prediction processing according to Embodiment 1;

FIG. 9B explains CIR_eq prediction processing according to Embodiment 1;

FIG. 10 shows pilot block assignment according to Embodiment 2;

FIG. 11 shows pilot block assignment according to Embodiment 2;

FIG. 12 shows pilot block assignment according to Embodiment 3;

FIG. 13 explains cyclic shift setting processing according to Embodiment 4;

FIG. 14 shows pilot block assignment according to Embodiment 4;

FIG. 15 explains CIR-eq prediction processing according to Embodiment 4; and

FIG. 16 explains cyclic shift setting processing according to Embodiment 4.

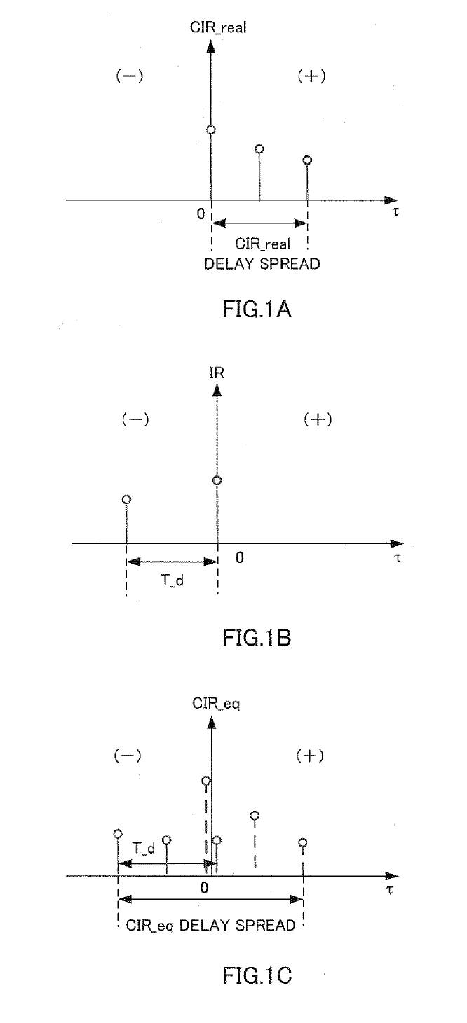

### DESCRIPTION OF EMBODIMENTS

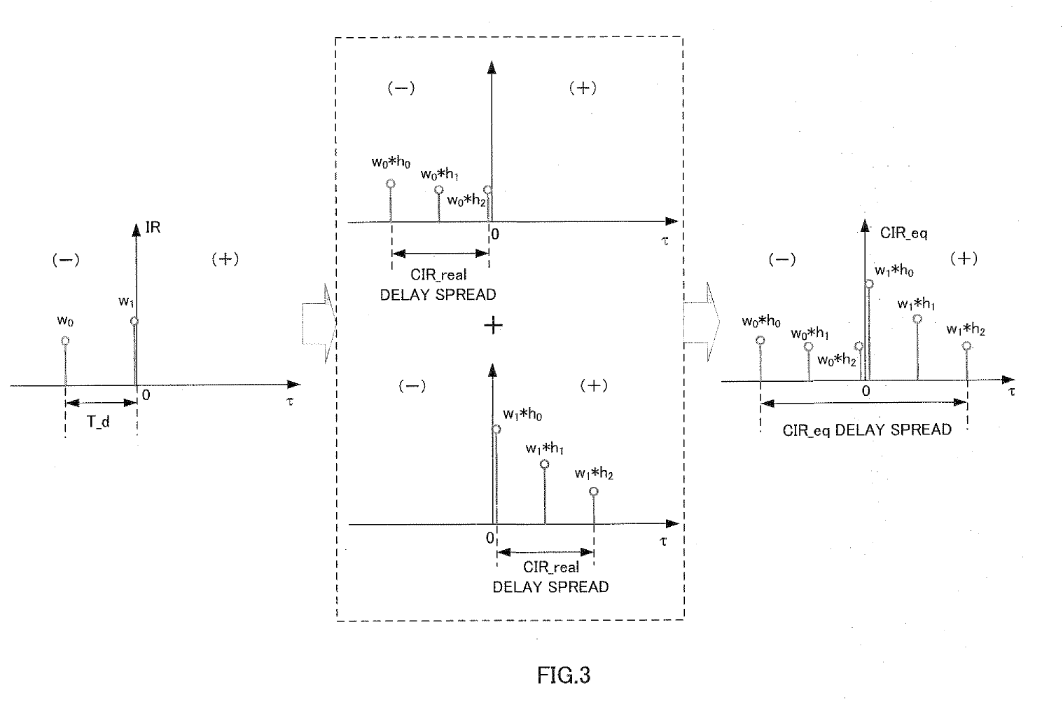

The inventors have arrived at the present invention by paying attention to the fact that CIR_eq is produced by convolution operation of IR and CIR_real and finding out that it is possible to predict the entire CIR_eq from only part of CIR_eq in CIR_eq delay spread, using weight information w of frequency-selective precoding, as shown in FIG. 3. This prediction is performed based on the fact that a plurality of paths constituting CIR_eq are correlated with each other. In FIG. 3, IR is represented by [w₀, w₁], and CIR_real is represented by [h₀, h₁, h₂].

Now, embodiments of the present invention will be described in detail with reference to the accompanying drawings.

### Embodiment 1

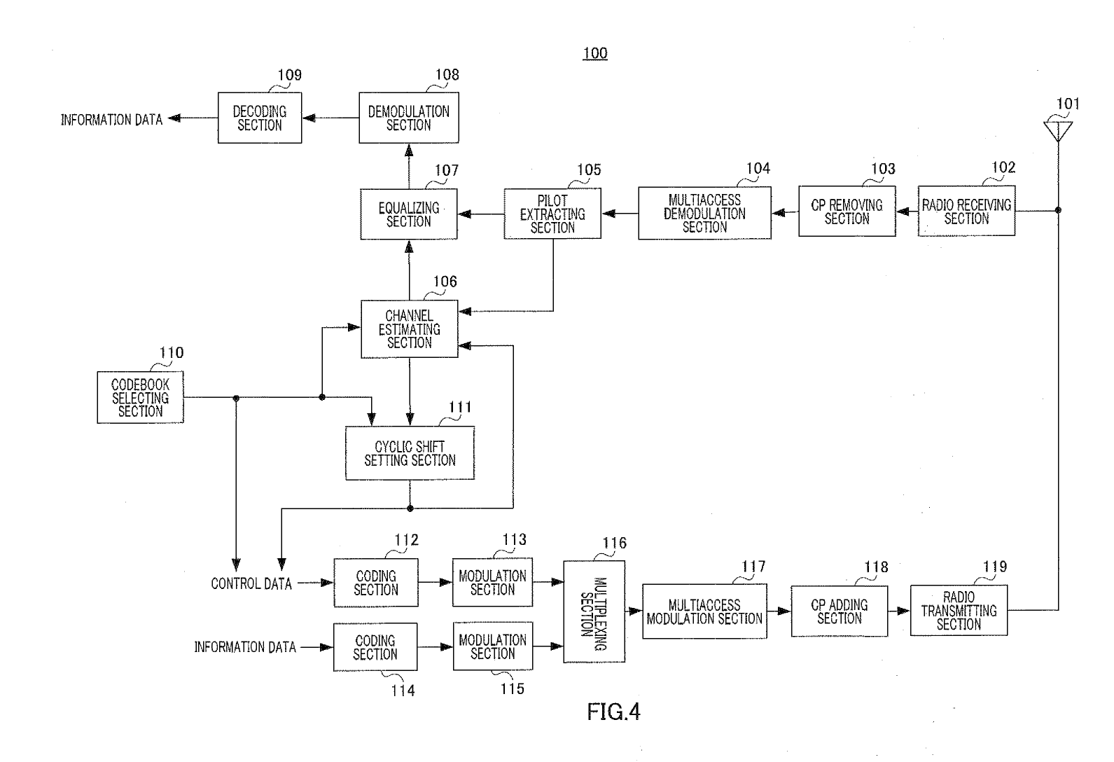

FIG. 4 shows a configuration of a base station according to the present embodiment. As shown in FIG. 4, base station 100 has antenna 101, radio receiving section 102, CP (cyclic prefix) removing section 103, multiaccess demodulation section 104, pilot extracting section 105, channel estimating section 106, equalizing section 107, demodulation section 108, decoding section 109, codebook section 110, cyclic shift setting section 111, coding section 112, modulation section 113, coding section 114, modulation section 115, multiplexing section 116, multiaccess modulation section 117, CP adding section 118 and radio transmitting section 119. Base station 100 is used in a radio communication system in which a plurality of pilot blocks having mutually different cyclic delays (cyclic shifts) are assigned to a plurality of UEs, respectively.

Radio receiving section 102 receives a signal transmitted from a UE described later via antenna 101, converts the received signal to a baseband signal and outputs the baseband signal to CP removing section 103.

CP removing section 103 removes a CP from the baseband signal and outputs a signal without a CP to multiaccess demodulation section 104.

Multiaccess demodulation section 104 transforms the signal without a CP from a time domain signal to a frequency domain signal using, for example, FFT (fast Fourier transform), and outputs that frequency domain signal to pilot extracting section 105.

Pilot extracting section 105 extracts dedicated pilot signals for respective UEs from inputted signals, and outputs those pilot signals to channel estimating section 106. In addition, pilot signal extracting section 105 outputs a remaining signal after extracting the pilot signal, that is, a data signal, to equalizing section 107.

Channel estimating section 106 performs channel estimation for each UE, using a CIR which is obtained from a dedicated pilot signal precoded by each UE and which resides in a pilot block per UE. Channel estimating section 106 removes a modulated component from an inputted dedicated pilot signal (that is, reverse-modulates a dedicated pilot signal), and then transforms a dedicated pilot signal after removing the modulated component (after reverse-modulation) to a time domain signal to obtain CIR_eq for each UE. Next, channel estimating section 106 calculates a time width equivalent to the CIR_real delay spread in each UE pilot block, based on cyclic shift information of each UE inputted from cyclic shift setting section 111 and multiplies IDFT output by a rectangular window having that time width to extract part of each UE CIR_eq. Next, channel estimating section 106 performs channel estimation using the extracted CIR_eq and codebook information of each UE, which is inputted from codebook selecting section 110. This prediction processing will be described in detail later. Then, channel estimating section 106 performs FFT on CIR_eq for each UE, calculates a channel estimation value (frequency transfer function) of the entire CIR_eq and outputs the result to equalizing section 107. In addition, channel estimating section 106 calculates CIRs (CIR_real, CIR_real delay spread and so forth) for each UE, from the precoding weight and CIR_eq for each UE, using codebook information about each UE inputted from codebook selecting section 110, and outputs that CIR information to cyclic shift setting section 111.

Equalizing section 107 calculates a frequency domain equalizing weight using a channel estimation value, performs equalizing processing, using that frequency domain equalizing weight, and outputs a data signal after equalizing processing to demodulation section 108.

Demodulation section 108 demodulates the data signal after equalizing processing and outputs demodulated data to decoding section 109.

Decoding section 109 decodes the demodulated data to obtain information data.

Codebook selecting section 110 selects the codebook for each UE from a plurality of codebooks stored in advance, based on a predetermined algorithm, and outputs that codebook information to cyclic shift setting section 111 and channel estimating section 106. In addition, codebook setting section 110 outputs the selected codebook information of each UE as control data. Codebook information includes precoding weight information about each UE.

Cyclic shift setting section 111 sets different cyclic delays (cyclic shifts) for pilot blocks assigned to UEs, and outputs cyclic shift information indicating the cyclic delay (cyclic shift) set for each UE to channel estimating section 106. In addition, cyclic shift setting section 111 outputs cyclic shift information as control data. This cyclic shift setting processing will be described in detail later.

Coding section 112 encodes control data composed of codebook information and cyclic shift information and outputs encoded control data to modulation section 113.

Modulation section 113 modulates the encoded control data and outputs a control data signal after modulation to multiplexing section 116.

Coding section 114 encodes information data and outputs encoded information data to modulation section 115.

Modulation section 115 modulates the encoded information data and outputs an information data signal after modulation to multiplexing section 116.

Multiplexing section 116 multiplexes a control data signal with an information data signal to generate a multiplexed data signal, and outputs the multiplexed data signal to multiaccess modulation section 117.

Multiaccess modulation section 117 transforms the multiplexed data signal from a frequency domain signal to a time domain signal, using, for example, IFFT, and outputs the time domain signal to CP adding section 118.

CP adding section 118 adds a CP to the time domain signal and outputs a signal with the CP to radio transmitting section 119.

Radio transmitting section 119 converts a baseband signal to an RF signal and transmits the RF signal to a UE described later, via antenna 101.

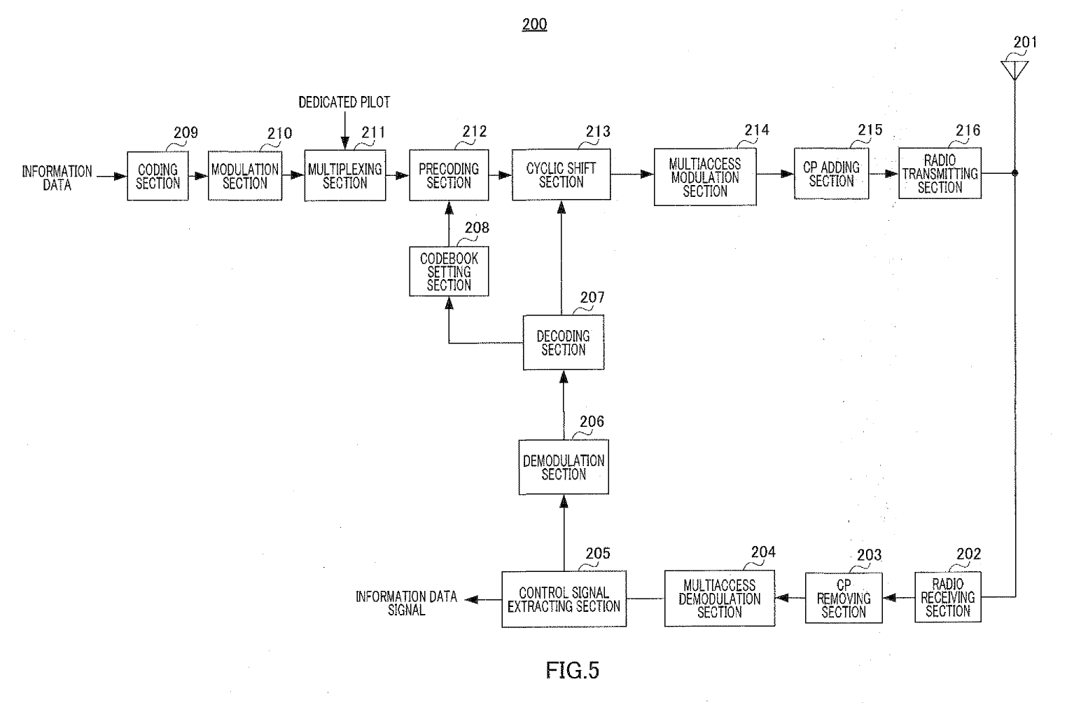

Next, FIG. 5 shows a configuration of a UE according to the present embodiment. As shown in FIG. 5, UE 200 has antenna 201, radio receiving section 202, CP removing section 203, multiaccess demodulation section 204, control signal extracting section 205, demodulation section 206, decoding section 207, codebook setting section 208, coding section 209, modulation section 210, multiplexing section 211, precoding section 212, cyclic shift section 213, multiaccess modulation section 214, CP adding section 215, and radio transmitting section 216. UE 200 is used in a radio communication system in which a plurality of pilot blocks having mutually different cyclic delays (cyclic shifts) are assigned to a plurality of UEs, respectively.

Radio receiving section 202 receives a signal transmitted from base station 100 via antenna 201, converts the received signal to a baseband signal and outputs the baseband signal to CP removing section 203.

CP removing section 203 removes the CP from the baseband signal and outputs a signal without a CP to multiaccess demodulation section 204.

Multiaccess demodulation section 204 transforms the signal without a CP from a time domain signal to a frequency domain signal using, for example, FFT, and outputs the frequency domain signal to control signal extracting section 205.

Control signal extracting section 205 extracts a control data signal from the inputted signal and outputs the control data signal to demodulation section 206. In addition, control signal extracting section 205 outputs a remaining signal after extracting the control data signal, that is, an information data signal.

Demodulation section 206 demodulates the control data signal and outputs control data after demodulation to decoding section 207.

Decoding section 207 decodes the control data after demodulation and outputs decoded control data to codebook setting section 208 and cyclic shift section 213. This control data includes codebook information and cyclic shift information as described above.

Codebook setting section 208 selects the codebook directed to UE 200, among a plurality of codebooks stored in advance, based on codebook information reported from base station 100, and sets a precoding weight corresponding to the selected codebook in precoding section 212.

Coding section 209 encodes information data and outputs encoded information data to modulation section 210.

Modulation section 210 modulates the encoded information data and outputs information after modulation to multiplexing section 211.

Multiplexing section 211 multiplexes the information data signal with a dedicated pilot signal and outputs the result to precoding section 212.

Precoding section 212 applies frequency-selective precoding to an information data signal and a dedicated pilot signal by multiplying the information data signal and the dedicated pilot signal by a preceding weight set by codebook setting section 208, and outputs an information data signal and a pilot signal after precoding to cyclic shift section 213.

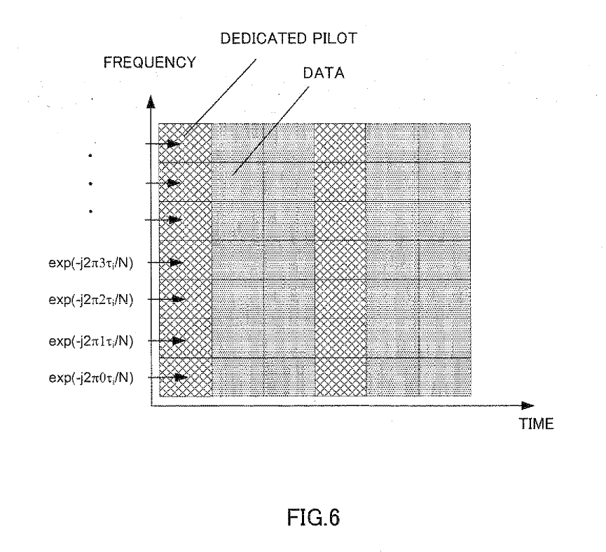

Cyclic shift section 213 cyclic-delays a dedicated pilot signal by the cyclic delay (cyclic shift) set for UE 200, based on cyclic shift information reported from base station 100, and outputs a dedicated pilot signal after cyclic delay to multiaccess modulation section 214. By this cyclic delay processing (cyclic shift processing), a pilot block assigned to UE 200 is delayed by the cyclic delay (cyclic shift) set for UE 200. That is, radio transmitting section 216 transmits a dedicated pilot signal subjected to precoding to base station 100, using the pilot block after this cyclic delay. Here, since cyclic shift is performed on a dedicated pilot signal in the frequency domain, cyclic shift section 213 applies the amount of phase rotation equivalent to the cyclic delay (cyclic shift) set for UE 200, to the dedicated pilot signal, as shown in FIG. 6. In FIG. 6, exp(−j2pnt₁/N) represents the phase rotation applied to a dedicated pilot signal on an N-th subcarrier after precoding, tᵢ represents the cyclic delay (cyclic shift) set for UE 200 (UE #i), and N represents the number of FFT points.

Here, it may be possible to perform cyclic shift on a dedicated pilot signal before precoding.

In addition, it may be possible to perform cyclic shift on a dedicated pilot signal in the time domain. In this case, UE 200 has cyclic shift section 213 between multiaccess modulation section 214 and CP adding section 215. Then, cyclic shift section 213 cyclic-delays (cyclic-shifts) a time domain dedicated pilot signal outputted from multiaccess modulation section 214, by the cyclic delay (cyclic shift) set for UE 200.

Multiaccess modulation section 214 transforms an information data signal and a dedicated pilot signal from frequency domain signals to time domain signals, using, for example, IFFT, and outputs the time domain signals to CP adding section 215.

CP adding section 215 adds a CP to each time domain signal and outputs a signal with a CP to radio transmitting section 216.

Radio transmitting section 216 converts a baseband signal to an RF signal and transmits the RF signal to base station 100 via antenna 201.

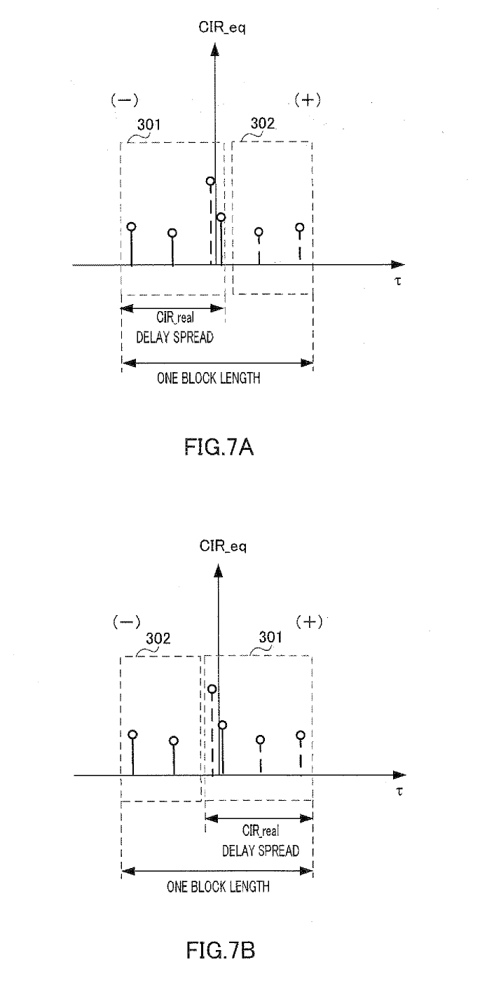

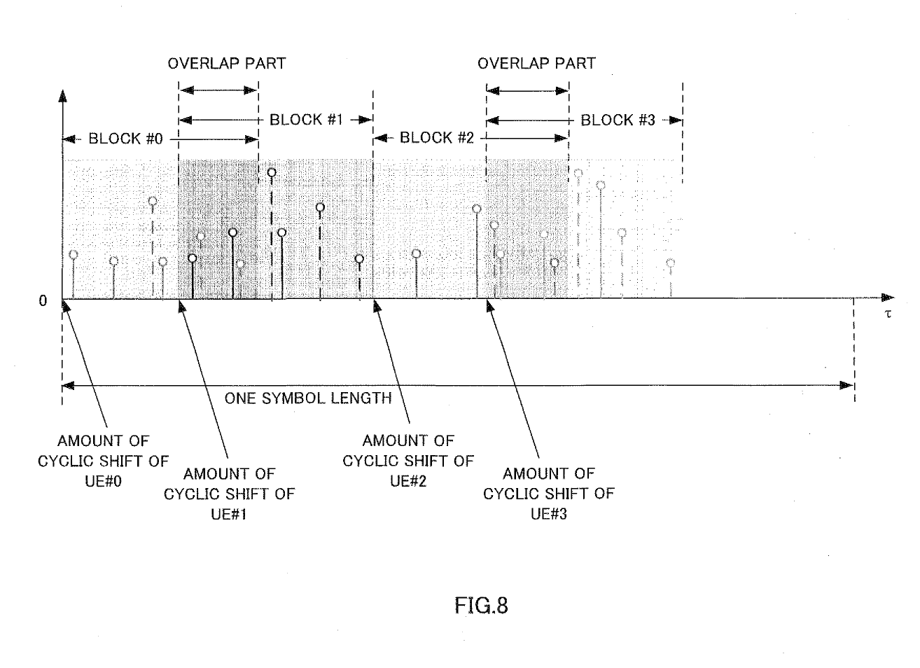

Next, cyclic shift setting processing in cyclic shift setting section 111 in base station 100 will be explained with reference to FIGS. 7A and B, and FIG. 8.

First, CIR_eq is calculated by performing convolution operation of a precoding weight and CIR_real per UE, based on precoding weight information and CIR information of each UE to calculate CIR_eq delay spread. Then, a length equivalent to the CIR_eq delay spread calculated per UE (or the equivalent length+a margin length) is determined as one block length of a pilot block assigned to each UE (FIGS. 7A and B.). Here, CIR_eq obtained by channel estimating section 106 may be used, and a length corresponding to the CIR_eq delay spread may be one block length of a pilot block.

Next, CIR_real delay spread is calculated per UE, based on CIR information of each UE. Then, a pilot block is divided into first part 301 and second part 302, based on the CIR_real delay spread and the one block length (FIGS. 7A and B.) Here, in one pilot block, the first half part or second half part corresponding to the CIR_eq delay spread is first part 301, and the other part is second part 302. Therefore, the first part and the second part are consecutively set in the first half part and the second half part in one pilot block.

Next, a cyclic delay (cyclic shift) for each pilot block is set such that second part 302(+) of one pilot block and second part 302(−) of the neighboring pilot block overlap one another. That is, the second half part of one pilot block and the first half part of the other pilot block overlap one another (FIG. 8.) By this means, for example, as shown in FIG. 8, when pilot blocks #0 to #3 are assigned to UEs #0 to #3, respectively, a cyclic delay (cyclic shift) for each pilot block is set such that the second half part of pilot block #0 and the first half part of pilot block #1 overlap, and the second half part of pilot block #2 and the first half part of pilot block #3 overlap.

As described above, cyclic shift setting section 111 sets a cyclic delay (cyclic shift) for each of a plurality of pilot blocks such that part of one pilot block and part of the neighboring pilot block overlap one another.

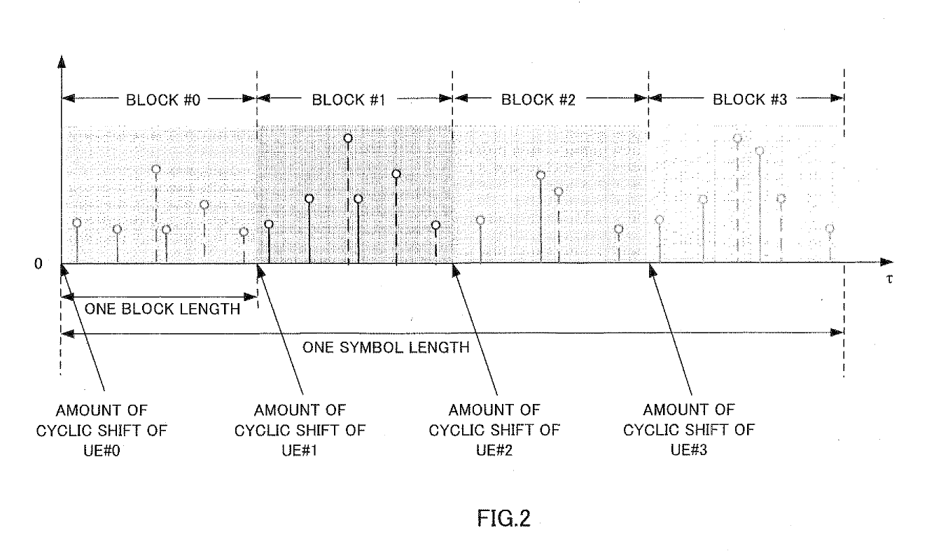

Therefore, according to the present embodiment, as is clear from comparison between FIG. 2 and FIG. 8, it is possible to save dedicated pilot signal resources equivalent to a length for overlapping parts. Moreover, according to the present embodiment, if a length of overlapping parts is equal to or more than one block length, it is possible to delay time-multiplex the number of pilot blocks equal to or greater than “one symbol length/CIR_eq delay spread.” That is, according to the present embodiment, it is possible to improve the efficiency of use of resources for precoded dedicated pilot signals.

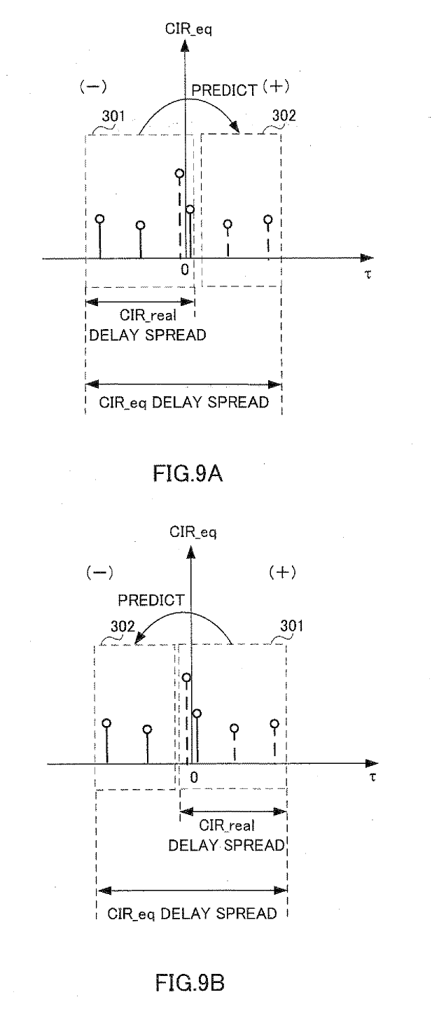

Next, CIR_eq prediction processing in channel estimating section 106 in base station 100 will be explained with reference to FIGS. 9A and B.

### Prediction Processing Example 1

First, as shown in FIG. 9A and equation 1, as for CIR_eq, impulse response h˜in second half part 302 (the second part (+)) in a pilot block is linearly predicted by multiplying impulse response ĥ extracted from first half part 301 (the first part (−) in the pilot block by weight P of a backward linear prediction filter.

[1]

\tilde{h}_{CIR}_{_{—}}_{eq}_{_{—}}ₗₐₜₜₑᵣ=P_{backward}_{_{—}}_{pred}ĥ_{CIR}_{_{—}}_{eq}_{_{—}}_{front} (Equation 1)

Then, as shown in equation 2, channel estimation value h˜ for the entire CIR_eq is obtained by combining ĥ and h˜obtained by equation 1.

[2]

\tilde{h}_{CIR}_{_{—}}_{eq}_{_{—}}_{front}+\tilde{h}_{CIR}_{_{—}}_{eq}_{_{—}}ₗₐₜₜₑᵣ (Equation 2)

Likewise, as shown in FIG. 9B and equation 3, as for CIR_eq, impulse response h˜ for first half part 302 (the second part (−)) of a pilot block is linearly predicted by multiplying impulse response ĥ extracted from the second half part 301 (the first part (+)) of the pilot block by weight P of a forward linear prediction filter.

[3]

\tilde{h}_{CIR}_{_{—}}_{eq}_{_{—}}_{front}=P_{forward}_{_{—}}_{pred}ĥ_{CIR}_{_{—}}_{eq}_{_{—}}ₗₐₜₜₑᵣ (Equation 3)

Then, as shown in equation 4, channel estimation value h˜ for the entire CIR_eq is obtained by combining ĥ and h˜ obtained by equation 3.

[4]

\tilde{h}_{CIR}_{_{—}}_{eq}=\tilde{h}_{CIR}_{_{—}}_{eq}_{_{—}}_{front}+ĥ_{CIR}_{_{—}}_{eq}_{_{—}}ₗₐₜₜₑᵣ (Equation 4)

Here, as the weight of a linear prediction filter, for example, the weight described in S. Haykin, “Adaptive filter theory,” 4^{th} edition, Prentice Hall, 2001, may be used.

As described above, with prediction processing example 1, the channel estimation value of an overlapping part is predicted from the channel estimation value of parts other than the overlapping part, using linear prediction. Therefore, according to prediction processing example 1, it is possible to accurately predict the channel estimation value of an overlapping part.

### Prediction Processing Example 2

As for CIR_eq shown in FIG. 3, it is found that h₀ to h₂ multiplied by precoding weight w₀ is and h₀ to h₂ by which precoding weight w₁ is multiplied, are different in the cyclic delay (shift) and the precoding weight, and hold a linear relationship. Therefore, it is possible to obtain the channel estimation value for the entire CIR_eq by predicting either h₀ to h₂ multiplied by precoding weight w₀ or h₀ to h₂ multiplied by precoding weight w₁, from the other.

For example, when the channel estimation value for the entire CIR_eq is obtained from h₀ to h₂ by which precoding weight w₀ is multiplied, first, in CIR_eq shown in FIG. 3, w₀*h₀, w₀*h₁, w₀*h₂ corresponding to the CIR_real delay spread is extracted. Next, w₀*h₀, w₀*h₁, w₀*h₂ are each multiplied by w₁/w₀. Next, the multiplication result is shifted T_d backward. By this means, w₁*h₀, w₁*h₁, w₁*h₂ are predicted from w₀*h₀, w₀*h₁, w₀*h₂. Then, the channel estimation value for the entire CIR_eq is obtained by combining the extracted w₀*h₀, w₀*h₁, w₀*h₂ and the predicted w₁*h₀, w₁*h₁, w₁*h₂.

For example, when the channel estimation value for the entire CIR_eq from h₀˜h₂ multiplied by w₁, first, in CIR_eq shown in FIG. 3, w₁*h₀, w₁*h₁, w₁*h₂ corresponding to the CIR_real delay spread is extracted. Next, w₁*h₀, w₁*h₁, w₁*h₂ are each multiplied by w₀/w₁. Next, the multiplication result is shifted T_d forward. By this means, w₀*h₀, w₀*h₁, w₀*h₂ are predicted from w₁*h₀, w₁*h₁, w₁*h₂. Then, the channel estimation value for the entire CIR_eq is obtained by combining the extracted w₁*h₀, w₁*h₁, w₁*h₂ and the predicted w₀*h₀, w₀*h₁, w₀*h₂.

As described above, with prediction processing example 2, the channel estimation value of an overlapping part is predicted by multiplying the channel estimation value of parts other than the overlapping part by a precoding weight. Therefore, according to prediction processing example 2, it is possible to easily predict the channel estimation value of an overlapping part more than in prediction processing example 1.

### Embodiment 2

There are a plurality of UEs 200 in the radio communication area covered by base station 100, that is, in the cell of base station 100, the distance between base station 100 and each of a plurality of UEs varies per UE. In addition, the shapes of obstacles and reflectors existing in a channel between base station 100 and each UE 200 are different per UE. Therefore, the channel of each UE is generally independent, and CIR delay spread varies per UE.

Therefore, with the present embodiment, cyclic shift setting section 111 sets a cyclic delay (cyclic shift) for each of a plurality of pilot blocks such that pilot blocks assigned to UEs having delay spreads of similar sizes are arranged adjacently.

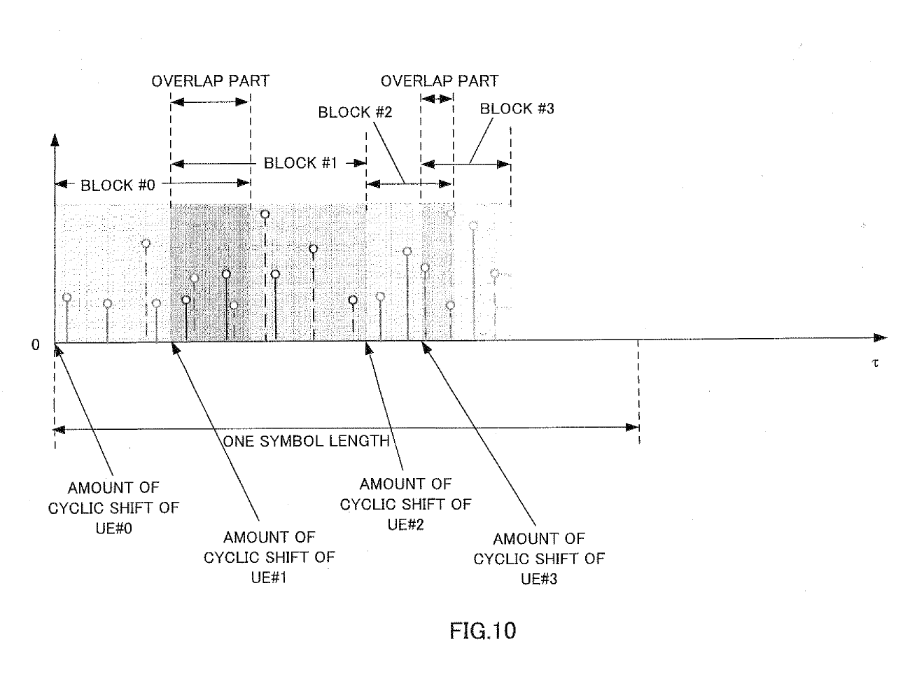

Now, only differences from Embodiment 1 will be described with reference to FIG. 10.

Cyclic shift setting section 111 compares the length of second part 302 in FIGS. 7A and B between pilot blocks, and sets a cyclic delay (cyclic shift) for each pilot block such that pilot blocks having second parts 302 with similar lengths overlap one another. In FIG. 10, UE #0 and UE #1 are located in the cell edge and have large CIR delay spread. Meanwhile, UE #2 and UE #3 are located in the cell center and have small CIR delay spread.

Therefore, in FIG. 10, a cyclic delay (cyclic shift) for each pilot block is set such that pilot block #0 and pilot block #1 are arranged adjacently and pilot block #2 and pilot block #3 are arranged adjacently. In addition, a cyclic delay (cyclic shift) for each pilot block is set such that the second half part of pilot block #0 and the first half part of pilot block #1 overlap, and the second half part of pilot block #2 and the first half part of pilot block #3 overlap.

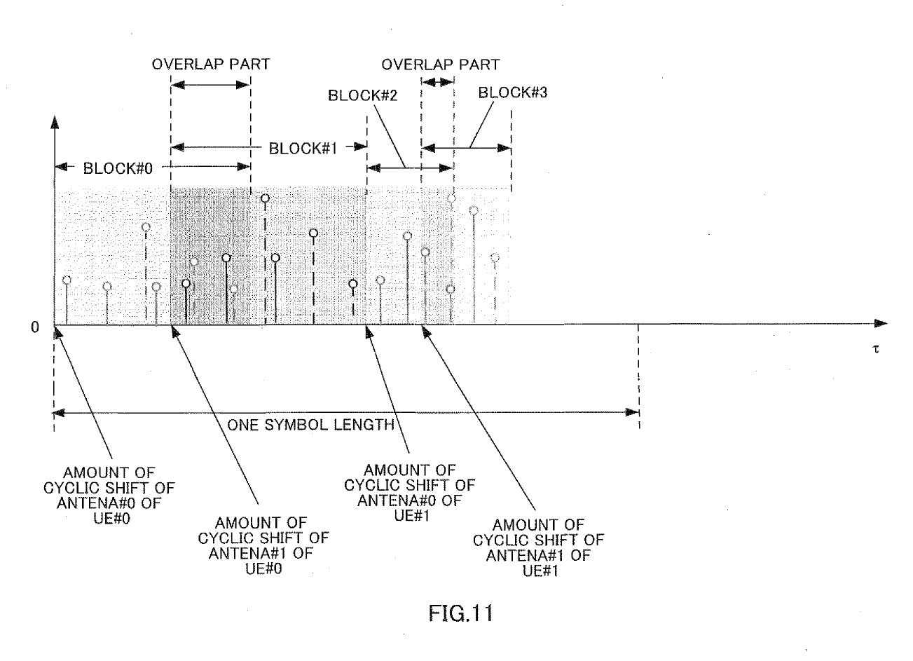

Here, when a UE has a plurality of antennas, the plurality of antennas have similar CIR delay spreads. Therefore, when each UE has a plurality of antennas, and pilot blocks are assigned to the plurality of antennas, respectively, cyclic shift setting section 111 may set a cyclic delay (cyclic shift) for each of a plurality of pilot blocks such that pilot blocks assigned to different antennas in the same UE are arranged adjacently as shown in FIG. 11.

In FIG. 11, UE #0 is located in the cell edge and has large CIR delay spread. Meanwhile, UE #1 is located in the cell center and has small CIR delay spread. In addition, pilot block #0 is assigned to antenna #0 in UE #0, pilot block #1 is assigned to antenna #1 in UE #0, pilot block #2 is assigned to antenna #0 in UE #1, and pilot block #3 is assigned to antenna #1 in UE #1, respectively. Therefore, in FIG. 11, a cyclic delay (cyclic shift) for each pilot block is set such that pilot block #0 and pilot block #1 are arranged adjacently, and pilot block #2 and pilot block #3 are arranged adjacently. In addition, a cyclic delay (cyclic shift) for each pilot block is set such that the second half part of pilot block #0 and the first half part of pilot block #1 overlap, and the second half part of pilot block #2 and the first half part of pilot block #3 overlap.

As described above, according to the present embodiment, when there are a plurality of UEs having mutually different delay spreads in the same cell, it is possible to increasingly improve the efficiency of use of resources for precoded dedicated pilot signals.

### Embodiment 3

If there is no delay time with each path of CIR_real or CIR_eq in sample points, sidelobe appears in CIR_eq for each UE obtained in channel estimating section 106, so that interference occurs due to sidelobe leakage between neighboring pilot blocks. The magnitude of this interference depends on the magnitude of difference in reception power of dedicated pilot signals between neighboring blocks, that is, the difference in energy between neighboring blocks.

Therefore, with the present embodiment, cyclic shift setting section 111 sets a cyclic delay (cyclic shift) for each of a plurality of pilot blocks such that pilot blocks having similar magnitude of energy are arranged adjacently.

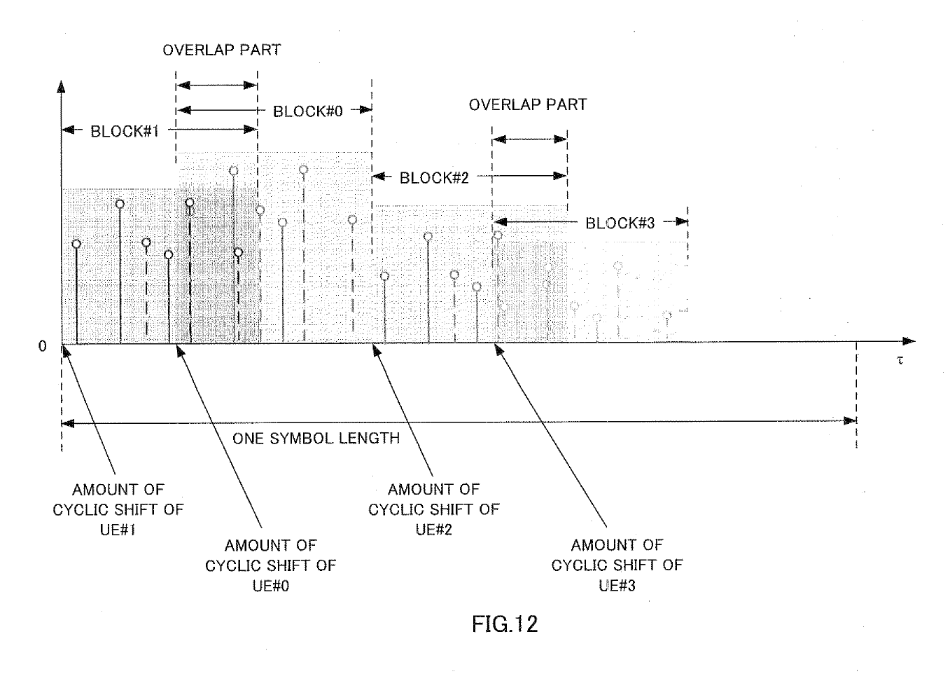

Now, only differences from Embodiment 1 will be explained with reference to FIG. 12.

Cyclic shift setting section 111 measures the energy of the entire CIR_eq (or first part 301 in FIGS. 7A and B) in each pilot block per UE. Then, cyclic shift setting section 111 compares the measured energy between pilot blocks, and sets a cyclic delay (cyclic shift) for each pilot block such that pilot blocks having similar magnitude of energy overlap one another. To be more specific, cyclic shift setting section 111 sets a cyclic delay (cyclic shift) for each pilot block such that the pilot block having the maximum energy is located in the center and the other pilot blocks are arranged in descending order of magnitude of energy, or such that the pilot block having the minimum energy is located in the center and the other pilot blocks are arranged in ascending order of magnitude of energy.

For example, in FIG. 12, the magnitude of energy of pilot blocks increases in the order of pilot blocks #0, #1, #2 and #3. Therefore, cyclic shift setting section 111 sets a cyclic delay (cyclic shift) for each pilot block such that pilot block #0 having the maximum energy is located in the center and other pilot blocks #1, #2, #3 are arranged in descending order of magnitude of energy.

By this means, with the present embodiment, the difference in energy between neighboring blocks is reduced. Therefore, according to the present embodiment, it is possible to reduce interference between neighboring blocks, so that even if there are a plurality of pilot blocks having mutually different magnitudes of energy, it is possible to prevent the accuracy of channel estimation from deteriorating.

Here, when a UE has a plurality of antennas, dedicated pilot signals transmitted from the plurality of antennas are received in base station 100 with similar reception power to each other. Therefore, when each UE has a plurality of antennas and pilot blocks are assigned to the plurality of antennas, respectively, cyclic shift setting section 111 may set a cyclic delay (cyclic shift) for each of a plurality of pilot blocks such that pilot blocks assigned to different antennas in the same UE are arranged adjacently. By this means, when a UE has a plurality of antennas, it is possible to reduce the difference in energy between neighboring blocks.

In addition, power of pilot blocks may be used instead of energy of pilot blocks.

### Embodiment 4

With Embodiment 1, the overlapping part (second part) is set in either the first half part or the second half part of a pilot block. Here, the power of CIR_eq is not uniform in one block but is concentrated in the center part in one block. The reason for this is that, with precoding, a dedicated pilot signal is multiplied by a weight determined in order to reduce reception data signal distortion, or increase reception SNR (signal to noise ratio), so that main power appears disproportionately near “delay time=0” as for CIR_eq. This phenomenon suggests that the accuracy of channel estimation can be improved by preferentially using the center part of CIR_eq in one block for channel estimation.

Therefore, with the present embodiment, overlapping parts (second parts) are set in both end parts of a pilot block.

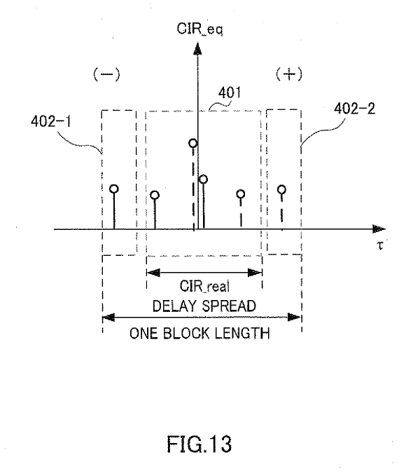

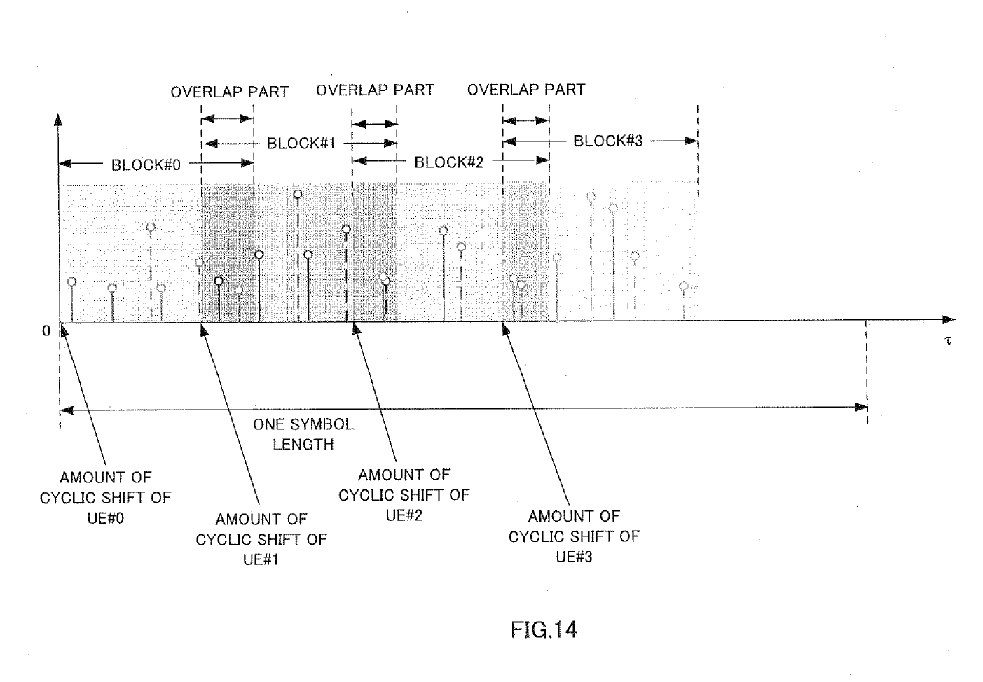

Now, cyclic shift setting processing in cyclic shift setting section 111 according to the present embodiment will be explained with reference to FIG. 13 and FIG. 14. Here, processing up to determination of one block length is the same as in Embodiment 1, so that descriptions will be omitted.

First, CIR_real delay spread is calculated per UE, based on CIR information of each UE. Then, a pilot block is divided into first part 401 and second parts 402-1 and 402-2, based on the CIR_real delay spread and one block length (FIG. 13.) Here, in one pilot block, the center part (part in which power is concentrated) corresponding to the CIR_eq delay spread is first part 401, and the other, both end parts (parts in which power is not concentrated) are second parts 402-1(−) and 402-2(+). By this means, those second parts are set in both ends of the first part in one pilot block and iteratively arranged.

Next, a cyclic delay for each pilot block is set between the first pilot block and the neighboring second pilot block and between the second pilot block and the neighboring third pilot block such that second part 402-2(+) of the first pilot block and second part 402-1(−) of the second pilot block overlap one another, and second part 402-2(+) of the second pilot block and second part 420-1(−) of the third pilot block overlap one another. That is, both ends of each pilot block overlap one another (FIG. 14.) Therefore, as shown in FIG. 14, when pilot blocks #0 to #3 are assigned to UEs #0 to #3, respectively, a cyclic delay (cyclic shift) for each pilot block is set such that the rear end part of pilot block #0 and the front end part of pilot block #1 overlap, the rear end part of pilot block #1 and the front end part of pilot block #2 overlap, and the rear end part of pilot block #2 and the front end part of pilot block #3 overlap.

As described above, cyclic shift setting section 111 sets a cyclic delay (cyclic shift) for each of a plurality of pilot blocks are set such that part of one pilot block and part of the neighboring pilot block overlap one another.

Therefore, according to the present embodiment, as is clear from comparison between FIG. 2 and FIG. 14, it is possible to save dedicated pilot signal resources equivalent to the length for overlapping parts. In addition, according to the present embodiment, if the length of overlapping parts is equal to or longer than one block length, it is possible to delay time-multiplex the number of pilot blocks equal to or greater than “one symbol length/CIR_eq delay spread.” That is, according to the present embodiment, it is possible to improve the efficiency of use of resources for dedicated pilot signals subjected to precoding, like in Embodiment 1.

In addition, according to the present embodiment, overlapping parts are set in both ends (parts in which power is not concentrated) of each pilot block to concentrate the main power of CIR_eq in parts that do not overlap, so that it is possible to improve accuracy of channel estimation more than in Embodiment 1.

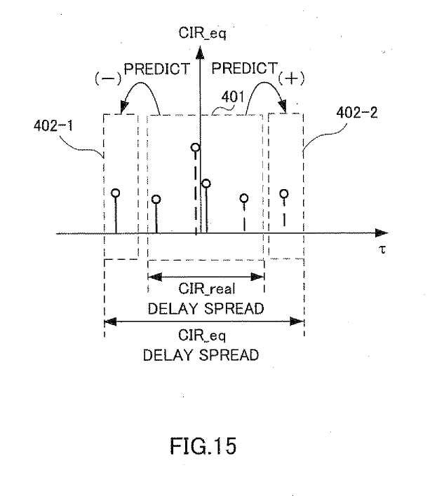

Next, CIR_eq prediction processing in channel estimating section 106 according to the present embodiment will be explained with reference to FIG. 15.

First, as shown in FIG. 15 and equation 5, as for CIR_eq, impulse response h˜ in front end part 402-1(−) of a pilot block is linearly predicted by multiplying impulse response ĥ extracted from center part 401 of the pilot block by weight P of a forward linear prediction filter.

[5]

\tilde{h}_{CIR}_{_{—}}_{eq}_{_{—}}_{forward}=P_{forward}_{_{—}}_{pred}ĥ_{CIR}_{_{—}}_{eq}_{_{—}}_{center} (Equation 5)

Likewise, as shown in FIG. 15 and equation 6, as for CIR_eq, impulse response h˜ in rear end part 402-2(+) of a pilot block is linearly predicted by multiplying impulse response 10 extracted from center part 401 of the pilot block by weight P of a backward linear prediction filter.

[6]

\tilde{h}_{CIR}_{_{—}}_{eq}_{_{—}}_{backward}=P_{backward}_{_{—}}_{pred}ĥ_{CIR}_{_{—}}_{eq}_{_{—}}_{center} (Equation 6)

Then, as shown in equation 7, channel estimation value h˜ of the entire CIR_eq is obtained by combining ĥ, h˜ obtained by equation 5, and h˜ obtained by equation 6.

[7]

\tilde{h}_{CIR}_{_{—}}_{eq}=ĥ_{CIR}_{_{—}}_{eq}_{_{—}}_{center}+\tilde{h}_{CIR}_{_{—}}_{eq}_{_{—}}_{forward}+\tilde{h}_{CIR}_{_{—}}_{eq}_{_{—}}_{backward} (Equation 7)

Here, as the weight of a linear prediction filter, for example, the weight described in S. Haykin, “Adaptive filter theory”, 4^{th} edition, Prentice Hall, 2001, may be used like in the above description.

As described above, according to the present embodiment, the channel estimation value of overlapping parts is predicted from the channel estimation value of parts other than the overlapping parts in which the main power is concentrated, using linear prediction. Therefore, according to the present embodiment, it is possible to accurately predict the channel estimation value of overlapping parts.

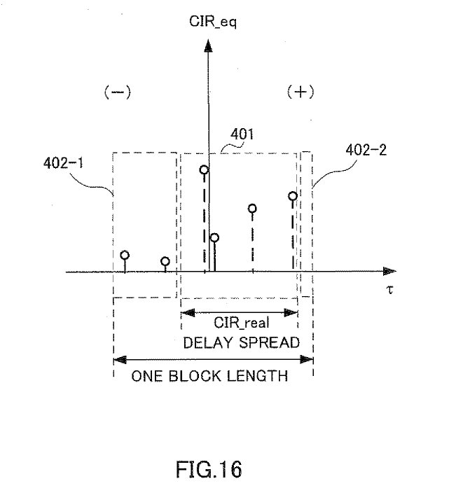

Here, as shown in FIG. 16, the length of front end part 402-1(−) may vary from the length of rear end part 402-2(+) by shifting part 401 (part that do not overlap) corresponding to the CIR_eq delay spread forward or backward from the center of one pilot block. FIG. 16 shows an example of backward shift. By this means, even if the main power of CIR_eq is slightly off the center of one block, it is possible to concentrate the main power of CIR_eq in parts that do not overlap.

The embodiments of the present invention has been described.

Here, in each embodiment, the first part (part that does not overlap) may be a part equivalent to a CP length. By this means, when the first part is determined, it is possible to skip processing of calculating CIR_real delay spread.

In addition, one block length may be a fixed value in Embodiments 1, 3 and 4. By this means, it is possible to skip processing of calculating one block length. For example, one block length preferably is a fixed value of “CP length+the maximum value of codebook impulse response delay spread.”

Moreover, in Embodiments 1, 3 and 4, one block length may be the same in all UEs. By this means, the lengths of second parts (parts to be overlapped) are the same in all UEs, so that it is possible to reduce overhead associated with reporting of the amount of cyclic shift.

In addition, in each embodiment, the amount of cyclic shift to report to each UE, may be defined as follows. By this means, only pilot block index number i (=2n or 2n+1, n=0, 1, . . . ) may be required to be reported to each UE, so that it is possible to reduce overhead associated with reporting of the amount of cyclic shift. A UE using an even-numbered pilot block: t₂ₙ=n×(one block length+CP length). A UE using an odd-numbered pilot block: t₂₊₁=n×(one block length+CP length)+CP length

In addition, it is possible to practice the present invention by adequately combining Embodiment 2 to 4.

Moreover, the present invention is applicable to dedicated pilot signals transmitted in the downlink (transmitted from a base station to UEs.)

Furthermore, the present invention is applicable to a radio communication system in which UEs select codebooks and report information of the selected codebooks to a base station.

A UE may also be referred to as “radio communication mobile station apparatus,” “MT,” “MS,” and “STA (station).”

A base station may also be referred to as “Node B,” “BS,” and “AP.” A subcarrier may also be referred to as “tone.” Moreover, a CP may also be referred to as “guard interval (GI).”

In addition, methods of transforming between the frequency domain and the time domain are not limited to IFFT, FFT, IDFT and DFT.

Moreover, the present invention is applicable to fixed and stationary UEs, or a radio communication relay station apparatus that performs relay and transmission between a base station and UEs. That is, the present invention is applicable to all radio communication apparatuses.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-195135, filed on Jul. 29, 2008, including the specification, drawings and abstract, is incorporated herein by reference in its entirety.

### INDUSTRIAL APPLICABILITY

The present invention is suitable for a mobile communication system and so forth.

1. A radio communication base station apparatus in a radio communication system in which a plurality of pilot blocks having mutually different cyclic delays, are assigned to a plurality of radio communication terminal apparatuses, respectively, the radio communication base station apparatus comprising:
an estimating section that performs channel estimation on each of the plurality of radio communication terminal apparatuses, using channel impulse responses that exist in the plurality of pilot blocks and that are obtained from dedicated pilot signals precoded by the plurality of radio communication terminal apparatuses, respectively; and
a setting section that sets the cyclic delay for each of the plurality of pilot blocks such that part of one pilot block and part of a neighboring pilot block overlap one another.

2. The radio communication base station apparatus according to claim 1, wherein the setting section:
divides each pilot block into a first part equivalent to equal to or greater than a channel delay spread or a cyclic prefix length, and a second part other than the first part; and
sets the cyclic delay for each of the plurality of pilot blocks such that second parts overlap one another.

3. The radio communication base station apparatus according to claim 2, wherein given two neighboring pilot blocks, the setting section sets the second part in a second half part of one pilot block and also in a first half part of the other pilot block.

4. The radio communication base station apparatus according to claim 2, wherein the setting section sets the second parts in both ends of each of the plurality of pilot blocks.

5. The radio communication base station apparatus according to claim 1, wherein the setting section sets the cyclic delay such that pilot blocks assigned to radio communication terminal apparatuses located in a cell edge overlap one another and pilot blocks assigned to radio communication terminal apparatuses located in a cell center overlap one another.

6. The radio communication base station apparatus according to claim 1, wherein, based on an energy of each of the plurality of pilot blocks, the setting section sets the cyclic delay such that a pilot block having a maximum energy is located in a center and the other pilot blocks are arranged in descending order of magnitude of energy on a time axis.

7. The radio communication base station apparatus according to claim 1, wherein, based on an energy of each of the plurality of pilot blocks, the setting section sets the cyclic delay such that a pilot block having a minimum energy is located in a center and the other pilot blocks are arranged in ascending order of magnitude of energy on a time axis.

8. The radio communication base station apparatus according to claim 2, wherein the estimating section predicts a channel estimation value of the second part, from a channel estimation value of the first part.

9. The radio communication base station apparatus according to claim 8, wherein the estimating section predicts the channel estimation value of the second part, by multiplying the channel estimation value of the first part by a precoding weight.

10. A radio communication terminal apparatus in a radio communication system in which a plurality of pilot blocks having mutually different cyclic delays are assigned to a plurality of radio communication terminal apparatuses, the radio communication terminal apparatus comprising:
a precoding section that precodes a dedicated pilot signal; and
a transmitting section that transmits the precoded dedicated pilot signal, using a pilot block assigned to the radio communication terminal apparatus, among the plurality of pilot blocks in which respective cyclic delays are set such that part of one pilot block and part of a neighboring pilot block overlap one another.

11. A cyclic delay setting method in a radio communication system in which a plurality of pilot blocks having mutually different cyclic delays are assigned to a plurality of radio communication terminal apparatuses, respectively, and channel estimation are performed for each of the plurality of radio communication terminal apparatuses, using channel impulse responses that exist in the plurality of pilot blocks and that are obtained from dedicated pilot signals precoded by the plurality of radio communication terminal apparatuses, respectively, the cyclic delay setting method comprising:
setting the cyclic delay for each of the plurality of pilot blocks such that part of one pilot block and part of a neighboring pilot block overlap one another.
